(19) United States
(12) Patent Application Publication
(10) Pub. No.: US 2009/0182495 A1
(43) Pub. Date: Jul. 16, 2009

(54) NAVIGATION SYSTEM WITH APPARATUS FOR DETECTING ACCURACY FAILURES

(75) Inventors: James A. McDonald, Minneapolis, MN (US); Kevin D. Vanderwerf, Oro Valley, AZ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ (US)

(21) Appl. No.: 12/014,650

(22) Filed: Jan. 15, 2008

(51) Int. Cl. G01C 21/00

(52) U.S. Cl. 701/200

(57) ABSTRACT

A navigation system for a vehicle having a receiver operable to receive a plurality of signals from a plurality of transmitters includes a processor and a memory device. The memory device has stored thereon machine-readable instructions that, when executed by the processor, enable the processor to determine a set of error estimates corresponding to delta pseudo-range measurements derived from the plurality of signals, determine an error covariance matrix for a main navigation solution, and, using a parity space technique, determine at least one protection level value based on the error covariance matrix.

### BACKGROUND OF THE INVENTION

In addition to providing a navigation solution, navigation systems should also be able to provide users with timely warnings indicating when it is not safe/acceptable to use the navigation solution. A navigation system with this capability is, by definition, a navigation system with integrity.

With GPS for example, satellite failures can occur which result in unpredictable deterministic range errors on the failing satellite. Satellite failures are rare (i.e., on the order of 1 every year), but safety-critical navigation systems must account for these errors. Typically, navigation systems (e.g., GPS Receivers) provide integrity on their position solution (i.e., horizontal position and altitude), but do not provide integrity on other navigation parameters, such as ground speed and vertical velocity.

### SUMMARY OF THE INVENTION

In an embodiment of the invention, a navigation system for a vehicle having a receiver operable to receive a plurality of signals from a plurality of transmitters includes a processor and a memory device. The memory device has stored thereon machine-readable instructions that, when executed by the processor, enable the processor to determine a set of error estimates corresponding to delta pseudo-range measurements derived from the plurality of signals, determine an error covariance matrix for a main navigation solution, and, using a parity space technique, determine at least one protection level value based on the error covariance matrix.

### BRIEF DESCRIPTION OF THE DRAWINGS

Preferred and alternative embodiments of the present invention are described in detail below with reference to the following drawings.

FIG. 1 shows a first navigation system incorporating embodiments of the present invention; and

FIG. 2 shows a second navigation system incorporating embodiments of the present invention;

FIG. 3 shows a process according to an embodiment of the invention;

FIG. 4 illustrates satellite transmitter constants of proportionality;

FIG. 5 depicts a noise scatter that would occur if there was a bias on the most difficult-to-detect satellite in the presence of expected noise; and

FIG. 6 illustrates determination of horizontal protection level according to an embodiment of the invention.

### DETAILED DESCRIPTION OF THE PREFERRED EMBODIMENT

An embodiment builds on many of the concepts applied to position integrity in order to provide integrity on the following navigation states: North Velocity, East Velocity, Ground Speed, Vertical Speed, Flight Path Angle, and Track Angle.

One or more embodiments may include a bank of filters/solutions (whether Kalman Filter or Least Squares) that may be composed of a main solution that processes all satellite measurements along with a set of sub-solutions; where each sub-solution processes one satellite fewer than the main solution.

Navigation systems primarily employ one of the following implementations in order to calculate a navigation solution: a Kalman Filter or a Least Squares Solution. In general, GPS receivers which have GPS satellite measurements (and possibly altitude aiding) use a Least Squares solution while Hybrid Inertial/GPS systems use a Kalman Filter. Both methods use a recursive algorithm which provides a solution via a weighted combination of predictions and measurements. However, a Least Squares Solution possesses minimal prediction capability and is therefore heavily influenced by measurements (in fact the weighting factor on predictions in a Least Squares Solution approaches zero with each iteration). A Kalman Filter on the other hand is able to take advantage of additional information about the problem; such as additional measurement data (e.g., inertial data) or additional information about system noise and/or measurement noise. This allows the Kalman Filter to continuously vary its weighting on its own predictions versus measurement inputs (this may be done via the Kalman Gain). A Kalman Filter with very low confidence in its own predictions (i.e., a very large Kalman Gain) will behave much like a Least Squares Solution.

The Error Covariance Matrix, often denoted by the symbol “P,” within a navigation system represents the standard deviation of the error state estimates within a navigation solution. For example, given a 3×3 matrix representing the error covariance for the x, y, and z velocity states within a Kalman filter:

$$P = [ \begin{matrix}{σ}_{x}^{2} & E [ {σ}_{x} {σ}_{y} ] & E [ {σ}_{x} {σ}_{z} ] \\ E [ {σ}_{y} {σ}_{x} ] & {σ}_{y}^{2} & E [ {σ}_{y} {σ}_{z} ] \\ E [ {σ}_{z} {σ}_{x} ] & E [ {σ}_{z} {σ}_{y} ] & {σ}_{z}^{2}\end{matrix} ]$$

We would expect (with a properly modeled Kalman Filter) that, under the condition that a satellite fault is not a factor, the absolute value of the difference between the true ground speed and the Kalman Filter's ground speed would exceed 2\sqrt{(σₓ²+σ_{y}²)}˜5%, or less, of the time. The same would be true for vertical velocity using 2\sqrt{σ_{z}²} instead. Note the off diagonal terms here represent cross-correlation between the velocities (how a change in x-velocity impacts a change in y-velocity or z-velocity for example).

The Solution Error Covariance Matrix P may be a critical component of any fault detection and integrity limit algorithm. For a Kalman Filter, P may be a fundamental part of the recursive Kalman Filter process. A Kalman Filter navigation solution may not be produced without the P matrix. With a Least-Squares solution, calculation of the actual navigation solution may not require use of an error covariance matrix. Therefore, a Least Squares Solution may only produce a P matrix if it is desired to provide integrity with the navigation solution. Calculation of a P matrix for a Least Squares solution is based on the satellite geometry (line of sight from user to all satellites in view) and an estimate of the errors on the satellite measurements.

Once a navigation system has an error covariance matrix along with its actual navigation solution, fault detection and calculation of integrity can be performed via Solution Separation or Parity Space Based techniques.

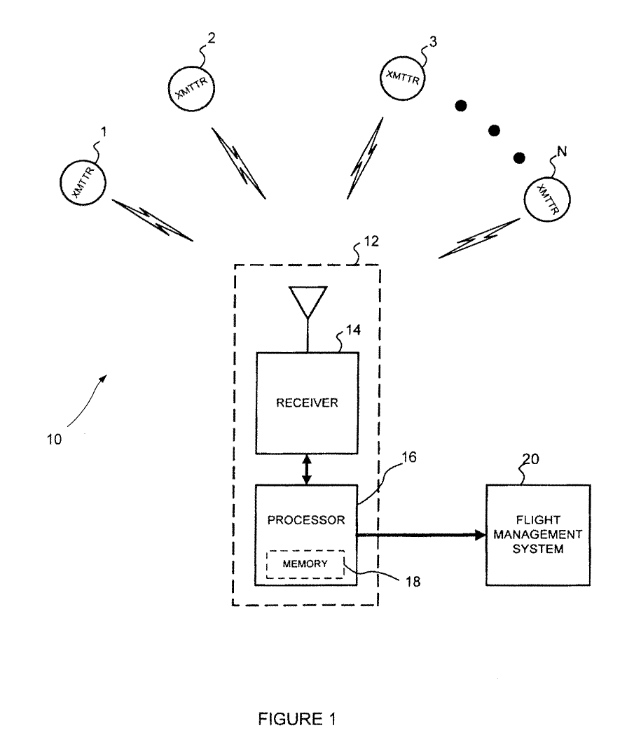

FIG. 1 shows a radio navigation system 10 incorporating features of an embodiment of the present invention. The system includes several transmitters 1-N and user set 12. Transmitters 1-N may be a subset of the NAVSTAR GPS constellation of satellite transmitters, with each transmitter visible from the antenna of user set 12. Transmitters 1-N broadcast N respective signals indicating respective transmitter positions and signal transmission times to user set 12.

User set 12, mounted to an aircraft (not shown), includes receiver 14, processor 16, and processor memory 18. Receiver 14, preferably NAVSTAR GPS compatible, receives the signals, extracts the position and time data, and provides pseudorange measurements to processor 16. From the pseudorange measurements, processor 16 can derive a position solution for the user set. Although the satellites can transmit their positions in World Geodetic System of 1984 (WGS-84) coordinates, a Cartesian earth-centered earth-fixed system, an embodiment determines the position solution in a local reference frame L, which is level with the north-east coordinate plane and tangential to the Earth. This frame choice, however, is not critical, since it is well-understood how to transform coordinates from one frame to another.

Processor 16 can also use the pseudorange measurements to detect satellite transmitter failures and to determine a worst-case error, or protection limit, both of which it outputs with the position solution to flight management system 20. Flight management system 20 compares the protection limit to an alarm limit corresponding to a particular aircraft flight phase. For example, during a pre-landing flight phase, such as nonprecision approach, the alarm limit (or allowable radial error) may be 0.3 nautical miles, but during a less-demanding oceanic flight phase, the alarm limit may be 2-10 nautical miles. (For more details on these limits, see RTCA publication DO-208, which is incorporated herein by reference.) If the protection limit exceeds the alarm limit, the flight management system, or its equivalent, announces or signals an integrity failure to a navigational display (not shown) in the cockpit of the aircraft. The processor also signals whether it has detected any satellite transmitter failures.

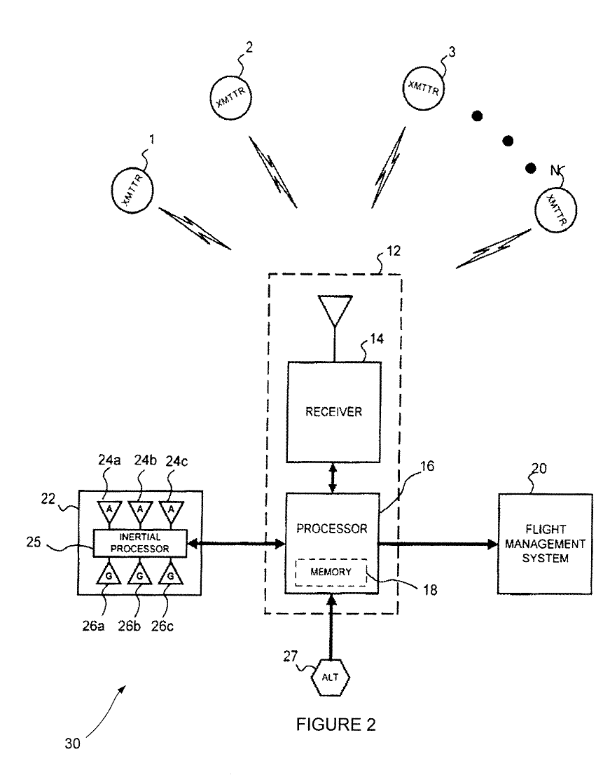

As shown in FIG. 2, a second embodiment extends the radio navigation system 10 of FIG. 1 with the addition of inertial reference unit 22 for providing inertial data to processor 16 and pressure altitude sensor 27 for providing altitude data to processor 16. The resulting combination constitutes a hybrid navigation system 30. (Altitude sensor 27 can also provide data to stabilize inertial reference unit, as known in the art, but for clarity the connection is not shown here.)

Inertial reference unit 22, mounted to the aircraft (not shown), preferably includes three accelerometers 24a-24c for measuring acceleration in three dimensions and three gyroscopes 26a-26c for measuring angular orientation, or attitude, relative a reference plane. Inertial reference unit 22 also includes inertial processor 25 which determines an inertial position solution rᵢ, preferably a three-element vector in an earth-fixed reference frame. Inertial processor 26 also preferably converts the acceleration data into raw acceleration vector a_{raw} and attitude data into raw angular velocity vector ω_{raw}. The preferred angular velocity vector defines the rotation of the body frame (fixed to the aircraft) in three dimensions, and the preferred inertial acceleration defines the three components of acceleration in body frame coordinates. Inertial processor 26 also determines a transformation matrix C for transforming body frame coordinates to local vertical frame L, a three-element rotation vector ω_{IE} which describes rotation of the earth-based frame E versus inertial frame I transformed to L frame, and rotation vector ω_{EL} which describes rotation of the L frame versus the earth-fixed frame E transformed to L frame. The details of this inertial processing are well known in the art.

An embodiment of the invention involves the processor 16 receiving pseudo-range and delta pseudo-range measurements from the receiver 14. The delta pseudo-range measurement from a GPS satellite represents the change in carrier phase over a specific time interval. The delta pseudo-range corresponds to the change (over that time interval) in user-satellite range plus receiver clock bias and can be used to determine the velocity of a user (along with the clock frequency of the user's clock). An embodiment of the invention determines the integrity values on horizontal and vertical velocities calculated from a least-squares solution and then applies those integrity values in order to obtain integrity for: North Velocity, East Velocity, Groundspeed, Vertical Velocity, track angle, and flight path angle for a hybrid navigation solution.

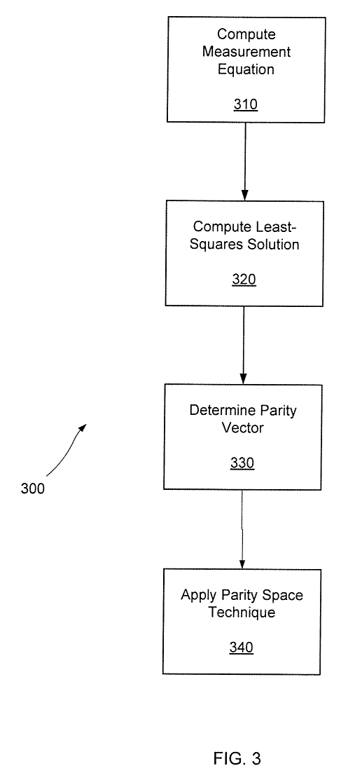

FIG. 3 illustrates a process 300, according to an embodiment of the invention, that can be implemented in one or both of systems 10 and 30. The process 300 is illustrated as a set of operations or steps shown as discrete blocks. The process 300 may be implemented in any suitable hardware, software, firmware, or combination thereof. As such the process 300 may be implemented in computer-executable instructions that can be transferred from one electronic device to a second electronic device via a communications medium. The order in which the operations are described is not to be necessarily construed as a limitation.

Referring to FIG. 3, at a step 310, the processor 16 determines a measurement equation. Assuming that the current position is known well enough by processor 16 to linearize the pseudo-range measurement equation and that N satellites are in view, the N-element vector of true pseudo-range residuals Δρ is related to the 4-element incremental user position and clock phase bias vector Δx as follows

ρ−\hat{ρ}=H(x−\hat{x})

Δρ=HΔx

where

$$H = [ \begin{matrix}- {LOS}_{1 x} & - {LOS}_{1 y} & - {LOS}_{1 z} & 1 \\ - {LOS}_{2 x} & - {LOS}_{2 y} & - {LOS}_{2 z} & 1 \\ ⋮ & ⋮ & ⋮ & ⋮ \\ - {LOS}_{Nx} & - {LOS}_{Ny} & - {LOS}_{Nz} & 1\end{matrix} ] , Δ x = [ \begin{matrix}Δ {r}_{x} \\ Δ {r}_{y} \\ Δ {r}_{z} \\ Δ {r}_{fc}\end{matrix} ] \qquad ( 2 )$$

and

Δrₓ, Δr_{y}, Δr_{z}=incremental x, y, and z position components

Δr_{tc}=incremental range error due to clock phase bias

\hat{x}=current estimate of the position/clock bias vector

\hat{ρ}=computed pseudo-range based on \hat{x}

LOSₓ, LOS_{y}, LOS_{z}=line-of-sight components of a unit vector pointing to satellite i (3)

Similarly, the N-element vector of true delta-ranges \dot{ρ} is related to the 4-element user velocity and clock frequency bias vector y as follows:

\dot{ρ}=Hy (4)

where

$$H = [ \begin{matrix}- {LOS}_{1 x} & - {LOS}_{1 y} & - {LOS}_{1 z} & 1 \\ - {LOS}_{2 x} & - {LOS}_{2 y} & - {LOS}_{2 z} & 1 \\ ⋮ & ⋮ & ⋮ & ⋮ \\ - {LOS}_{Nx} & - {LOS}_{Ny} & - {LOS}_{Nz} & 1\end{matrix} ] , y = [ \begin{matrix}{v}_{x} \\ {v}_{y} \\ {v}_{z} \\ {v}_{fc}\end{matrix} ] \qquad ( 5 )$$

and

νₓ, ν_{y}, ν_{z}=x, y, and z user velocity components

ν_{fc}=clock frequency bias

δ\dot{ρ}=vector of delta range errors (6)

Since the measured delta-ranges contains errors, the measured delta range residual is given by

[symbol]

=Hy+δ\dot{ρ} (7)

In the absence of a satellite failure, the processor 16 can assume that the delta range errors are uncorrelated Gaussian errors with zero mean and known variances. In order to de-weight measurements with larger errors, the processor 16 can normalize the delta range measurements as follows:

$$\overline{\dot{ρ}} = [ \begin{matrix}1 / {σ}_{dr} ( 1 ) & 0 & … & 0 \\ 0 & 1 / {σ}_{dr} ( 2 ) & … & 0 \\ ⋮ & ⋮ & ⋱ & ⋮ \\ 0 & 0 & … & 1 / {σ}_{dr} ( N )\end{matrix} ] [ \begin{matrix}{\tilde{\dot{ρ}}}_{1} \\ {\tilde{\dot{ρ}}}_{2} \\ ⋮ \\ {\tilde{\dot{ρ}}}_{N}\end{matrix} ] = \sqrt{W} \tilde{\dot{ρ}} \qquad ( 8 )$$

where σ_{dr}²(i) is the delta-range variance of the i^{th} satellite. Substituting (7) into (8) yields

$$\begin{matrix}\begin{matrix}{ρ}^{\overline{.}} = \sqrt{W} Hy + \sqrt{W} δ \dot{ρ} \\ = \overline{H} y + δ {ρ}^{\overline{.}}\end{matrix} & ( 9 ) \\ where & \\ \overline{H} = \sqrt{W} H & ( 10 ) \\ δ {ρ}^{\overline{.}} = \sqrt{W} δ \dot{ρ} & ( 9 )\end{matrix}$$

Note that each normalized delta-range error has unity variance (in the absence of a failure).

At a step 320, the processor 16 computes a least-squares solution. When there are more than 4 measurements, there exists an overdetermined set of linear equations (i.e., redundant measurements). In this case, the processor 16 can compute a least square estimate of y (i.e., one which minimizes the sum of the squared residuals) using the following

ŷ=( H̅^{T} H̅)⁻¹ H̅^{T} [symbol] = [symbol] (10)

Where S̅ can be referred to as the normalized least squares solution matrix. The processor 16 can take advantage of the redundancy in [symbol] in order to detect the presence of a satellite failure (an error that is well beyond that statistically expected). The processor 16 can extract this redundant information by performing orthogonal transformations on the measurement vector to map them into a parity space. An N×N orthogonal matrix Q can be found such that

$$Q \overline{H} = [ \begin{matrix}A \\ B\end{matrix} ] \overline{H} = [ \begin{matrix}{u}_{11} & {u}_{12} & {u}_{13} & {u}_{14} \\ 0 & {u}_{22} & {u}_{23} & {u}_{24} \\ 0 & 0 & {u}_{33} & {u}_{34} \\ 0 & 0 & 0 & {u}_{44} \\ 0 & 0 & 0 & 0 \\ ⋮ & ⋮ & ⋮ & ⋮ \\ 0 & 0 & 0 & 0\end{matrix} ] = [ \begin{matrix}U \\ 0\end{matrix} ] = \tilde{H} \qquad ( 11 )$$

Where A is the upper 4×N portion of Q and B is the lower (N−4)×N portion. The product Q H̅ results in the matrix \tilde{H} whose upper 4×4 portion is an upper triangular square matrix and whose lower (N−4)×4 portion is all zeros. Thus, if the processor 16 pre-multiplies (7) by Q, the result is:

$$Q \overline{\dot{ρ}} = Q \overline{H} y + Q δ \overline{\dot{ρ}} \\ [ \begin{matrix}A \\ B\end{matrix} ] \overline{\dot{ρ}} = [ \begin{matrix}U \\ 0\end{matrix} ] y + [ \begin{matrix}A \\ B\end{matrix} ] δ \overline{\dot{ρ}} \qquad ( 12 )$$

This equation can be partitioned into the following 2 equations

A [symbol] =Uy+Aδ [symbol] (13)

and

B [symbol] =Bδ [symbol] =p (14)

Solving (13) for the incremental solution Δy yields

y=U⁻¹A( [symbol] −δ [symbol] ) (15)

The least square estimate can be found by setting the delta range error vector to zero. Thus:

ŷ=U⁻¹A [symbol] (16)

This equation is a more efficient alternative to (10) since it only involves inverting an upper triangular matrix rather than a generalized inverse.

At a step 330, the processor 16 determines a parity vector. Equation (14) contains the redundant information. It maps the delta range measurements into an N−4 axis parity vector p which only depends on the delta range errors and the parity coefficient matrix B. Thus the magnitude of this parity vector can be used by the processor 16 to detect a satellite failure. A failure on a given satellite maps into a vector in a specific direction in the (N−4)-dimensional parity space. For example, assume that there are six satellites from which signals may be received. The parity space is then two-dimensional. Each sensor's direction in parity space is defined by the corresponding column of B. If satellite k has failed to a delta-range level of ε, then (ignoring the Gaussian noise in each delta-range measurement) the parity vector due to this bias error is

$$p = B δ \overline{\dot{ρ}} = [ \begin{matrix}{b}_{11} & … & {b}_{1 k} & … & {b}_{16} \\ {b}_{21} & … & {b}_{2 k} & … & {b}_{26}\end{matrix} ] [ \begin{matrix}0 \\ ⋮ \\ ɛ \\ ⋮ \\ 0\end{matrix} ] = [ \begin{matrix}{b}_{1 k} \\ {b}_{2 k}\end{matrix} ] ɛ \qquad ( 17 )$$

The magnitude of this parity vector is

|p|=|ε|\sqrt{b₁ₖ²+b₂ₖ²} (18)

In the absence of a failure, the parity error is

$$p = B δ \overline{\dot{ρ}} = B [ \begin{matrix}{w}_{1} \\ ⋮ \\ {w}_{k} \\ ⋮ \\ {w}_{N}\end{matrix} ] = Bw \qquad ( 19 )$$

where wᵢ are uncorrelated zero mean, unity variance Gaussian random errors. Since the rows of B are also rows of the orthonormal matrix Q, they are orthogonal unit vectors. Thus

BB^{T}=I_{N-4} (20)

The covariance of the parity vector is then

E[pp^{T}]=BE[ww^{T}]B^{T}=BB^{T}=I_{N-4} (21)

Thus the parity elements are also uncorrelated zero mean Gaussian random variables with unity variance.

At a step 340, the processor 16 applies a parity space technique. In an embodiment, the processor 16 employs a chi-square method using the concept of pbias. In such an embodiment, the processor 16 uses the square of the parity magnitude as the discriminator (test statistic) d as follows:

d=p^{T}p=p₁²+p₂²+ . . . +p_{N-4}² (22)

The discriminator will then have a central chi-square distribution with N−4 degrees of freedom. The processor 16 places a threshold on this discriminator above which a failure is declared. This threshold is computed by the processor 16 from the chi-square probability density function to yield an allowable false alarm probability.

Once the threshold has been set, the question becomes how large can the horizontal and vertical velocities be in the presence of a satellite failure as well as the random Gaussian errors with the discriminator just under the threshold given a certain probability of missed detection. This problem is complicated by the fact that the detection is being done in the parity space while the protection level is in the horizontal and vertical navigation space. A failure on a particular satellite could have a large impact on the discriminator (in the parity space) but have a small impact on the velocity (in the navigation space) or vice versa.

From (10), the estimated solution due to a delta-range bias error on satellite k is

$$\hat{y} = [ \begin{matrix}{\hat{v}}_{x} \\ {\hat{v}}_{y} \\ {\hat{v}}_{z} \\ {\hat{v}}_{fc}\end{matrix} ] = \overline{S} [ \begin{matrix}0 \\ ⋮ \\ ɛ \\ ⋮ \\ 0\end{matrix} ] = [ \begin{matrix}{\overline{s}}_{1 k} \\ {\overline{s}}_{2 k} \\ {\overline{s}}_{3 k} \\ {\overline{s}}_{4 k}\end{matrix} ] ɛ \qquad ( 23 )$$

Meanwhile the magnitude of the parity due to the delta-range bias error is

$$\vert p \vert = \sqrt{{p}^{T} p} = {( [ \begin{matrix}{b}_{1 k} & {b}_{2 k} & ⋮ & {b}_{( N - 4 ) , k}\end{matrix} ] [ \begin{matrix}{b}_{1 k} \\ {b}_{2 k} \\ ⋮ \\ {b}_{( N - 4 ) , k}\end{matrix} ] )}^{1 / 2} ɛ \\ = ɛ \sqrt{{Λ}_{kk}} \qquad ( 24 )$$

where

Λ=B^{T}B (25)

The horizontal velocity error due to a delta range bias error is proportional to the parity vector magnitude resulting from that same bias error. From (23) and (24), it can be shown that the horizontal velocity error due to a delta range bias error is proportional to the parity vector magnitude resulting from that same bias error. The constant of proportionality or slope is

$$slope ( k ) = \frac{\sqrt{{\overline{s}}_{1 k}^{2} + {\overline{s}}_{2 k}^{2}}}{\sqrt{{Λ}_{kk}}} \qquad ( 26 )$$

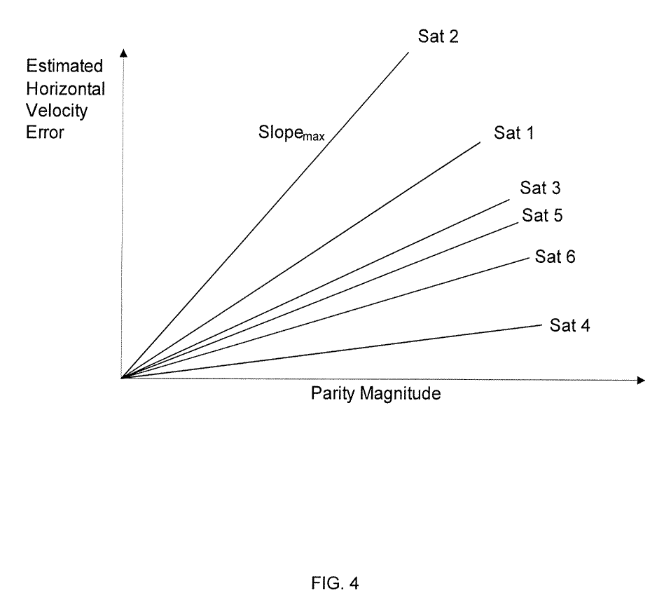

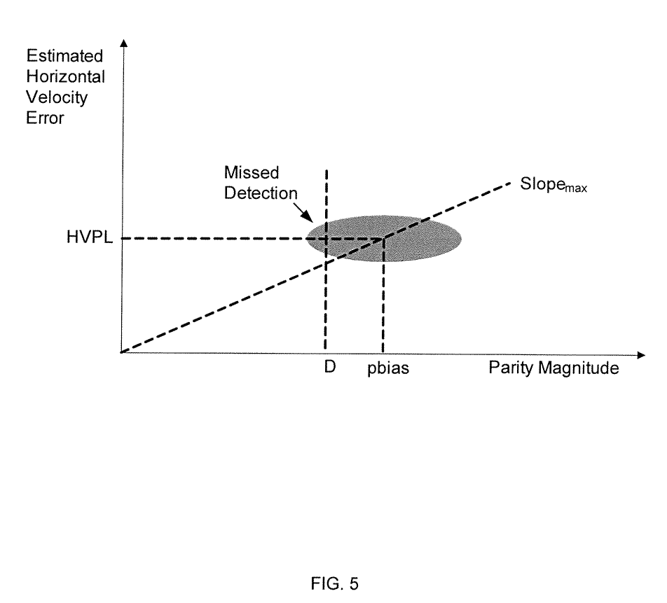

Each satellite has a unique slope determined by the satellite geometry. FIG. 4 illustrates this concept. The satellite with the largest slope is the most difficult to detect. This slope is referred to as Slopeₘₐₓ. FIG. 5 depicts a noise scatter that would occur if there was a bias on the most difficult-to-detect satellite in the presence of the expected noise. The specific bias that results in the percentage of data to the left of the detection threshold D equal to the missed detection probability is of particular interest. The parity magnitude associated with this bias is called pbias and the resulting horizontal velocity error is the horizontal velocity protection level (HVPL).

With the bias present, the discriminator (square of the parity magnitude) has a non-central chi-square distribution with N−4 degrees of freedom. It can be shown that the non-centrality parameter λ of the chi-square distribution is

λ=pbias² (27)

Thus, using the non-central chi-square probability density function, the processor 16 can determine the value for pbias which meets the required probability of missed detection.

For the special case when there are 5 visible satellites, the parity is a scalar and the chi-square distribution has only one degree of freedom and has a singularity at the origin. But in this case, the distribution of the parity magnitude is Gaussian and it is preferred over the chi-square distribution of the square of the parity magnitude.

As such, in an alternative embodiment, the processor 16 performs repeated rotations of the parity space such that the parity error of interest for a given satellite failure is a scalar and is Gaussian.

Recall that a bias on satellite k results in a bias in parity space along the direction defined by the k^{th} column of the parity coefficient matrix B. The processor 16 can perform additional orthogonal transformations of B (i.e. rotations of the parity space) such that this bias lies entirely along one axis of the parity space. The processor 16 designates this transformed B as B^{k}. The processor 16 can arbitrarily choose axis 1 as the bias direction. Thus:

$${B}^{k} = [ \begin{matrix}{b}_{1}^{k} & … & {b}_{k}^{k} & … & {b}_{N}^{k} \\ X & ⋮ & 0 & ⋮ & X \\ ⋮ & ⋮ & ⋮ & ⋮ & ⋮ \\ X & ⋮ & 0 & ⋮ & X\end{matrix} ] = [ \begin{matrix}{( {b}^{k} )}^{T} \\ X \\ X \\ X\end{matrix} ] \qquad ( 28 )$$

We are now only concerned with the first element of the parity vector. Thus the discriminator is

d^{k}=(b^{k})^{T}δ [symbol] (29)

Without a failure, the discriminator has a zero mean Gaussian distribution with unity variance. Thus, the processor 16 can compute the threshold D to meet the allowed probability of missed detection.

With a bias failure on the k^{th} satellite and random errors on all satellites, the discriminator becomes

$${d}^{k} = {( {b}^{k} )}^{T} δ {ρ}^{\overline{.}} = [ {b}_{1}^{k} {b}_{2}^{k} … {b}_{k}^{k} … {b}_{n}^{k} ] [ \begin{matrix}{w}_{1} \\ {w}_{2} \\ ⋮ \\ ɛ + {w}_{k} \\ ⋮ \\ {w}_{n}\end{matrix} ] \qquad ( 30 )$$

Re-arranging, this yields

$${d}^{k} = {b}_{k}^{k} ( ɛ + {w}_{k} ) + {\sum }_{k 1 \neq k} {b}_{k 1}^{k} {w}_{k 1} \qquad ( 31 )$$

Consequently, the impact of the pseudo-range errors on the horizontal position error is given by

$$δ {v}_{h} = {\overline{S}}^{h} δ {ρ}^{\overline{.}} = [ {\overline{s}}_{1}^{h} {\overline{s}}_{2}^{h} … {\overline{s}}_{k}^{h} … {\overline{s}}_{N}^{h} ] [ \begin{matrix}{w}_{1} \\ {w}_{2} \\ ⋮ \\ ɛ + {w}_{k} \\ ⋮ \\ {w}_{N}\end{matrix} ] \qquad ( 32 )$$

where

S̅^{h}=the first two rows (i.e. x and y) of the normalized least-squares solution matrix

s̅ᵢ^{h}=the i^{th} column of S̅^{h} (representing the impact of the i^{th} satellite on x and y velocity).

Again, re-arranging, this yields

$$δ {v}_{h} = {\overline{s}}_{k}^{h} ( ɛ + {w}_{k} ) + {\sum }_{k 1 \neq k} {\overline{s}}_{k 1}^{h} {w}_{k 1} \qquad ( 33 )$$

At detection, the magnitude of the discriminator (parity) is equal to the threshold D. That is:

|d^{m}|=D (34)

Substituting (34) into (31) yields

$$\vert {b}_{k}^{k} ( ɛ + {w}_{k} ) + {\sum }_{k 1 \neq k} {b}_{k 1}^{k} {w}_{k 1} \vert = D \qquad ( 35 )$$

If it is assumed that the failure g is positive and much larger than the noise, then:

$$\begin{matrix}\vert {b}_{k}^{k} \vert ( ɛ + {w}_{k} ) + {\sum }_{k 1 \neq k} {b}_{k 1}^{k} {w}_{k 1} = D & ( 36 ) \\ or & \\ ( ɛ + {w}_{k} ) = D / \vert {b}_{k}^{k} \vert - {\sum }_{k 1 \neq k} \frac{{b}_{k 1}^{k} {w}_{k 1}}{\vert {b}_{k}^{k} \vert} & ( 37 )\end{matrix}$$

Substituting (37) into (33) yields

$$δ {v}_{h} = {\overline{s}}_{k}^{h} [ D / \vert {b}_{k}^{k} \vert - {\sum }_{k 1 \neq k} \frac{{b}_{k 1}^{k} {w}_{k 1}}{\vert {b}_{k}^{k} \vert} ] + {\sum }_{k 1 \neq k} {\overline{s}}_{k 1}^{h} {w}_{k 1} \qquad ( 38 )$$

The processor 16 can obtain the projection of the horizontal velocity error vector in the direction of the failure by taking the dot product

$$\begin{matrix}\begin{matrix}δ {v}_{hk} = \frac{{\overline{s}}_{k}^{h}}{\vert {\overline{s}}_{k}^{h} \vert} \cdot δ {v}_{h} \\ = \frac{{\overline{s}}_{k}^{h} \cdot {\overline{s}}_{k}^{h}}{\vert {\overline{s}}_{k}^{h} \vert} [ D / \vert {b}_{k}^{k} \vert - {\sum }_{k 1 \neq k} \frac{{b}_{k 1}^{k} {w}_{k 1}}{\vert {b}_{k}^{k} \vert} ] + {\sum }_{k 1 \neq k} \frac{{\overline{s}}_{k}^{h} \cdot {\overline{s}}_{k 1}^{h}}{\vert {\overline{s}}_{k}^{h} \vert} {w}_{k 1} \\ = \vert {\overline{s}}_{k}^{h} \vert [ D / \vert {b}_{k}^{k} \vert - {\sum }_{k 1 \neq k} \frac{{b}_{k 1}^{k} {w}_{k 1}}{\vert {b}_{k}^{k} \vert} ] + {\sum }_{k 1 \neq k} \frac{{\overline{s}}_{k}^{h} \cdot {\overline{s}}_{k 1}^{h}}{\vert {\overline{s}}_{k}^{h} \vert} {w}_{k 1}\end{matrix} & ( 39 )\end{matrix}$$

Factoring out the visibility of the failed satellite and separating the noise and bias (failure) terms

$$\begin{matrix}\begin{matrix}δ {v}_{hk} = \frac{\vert {\overline{s}}_{k}^{h} \vert}{\vert {b}_{k}^{k} \vert} D + \frac{1}{\vert {b}_{k}^{k} \vert} {\sum }_{k 1 \neq k} [ ( \frac{{\overline{s}}_{k}^{h} \cdot {\overline{s}}_{k 1}^{h}}{\vert {\overline{s}}_{k}^{h} \vert} \vert {b}_{k}^{k} \vert - \vert {\overline{s}}_{k}^{h} \vert {b}_{k 1}^{k} ) {w}_{k 1} ] \\ = M + \frac{1}{\vert {b}_{k}^{k} \vert} {\sum }_{k 1 \neq k} {K}_{k 1} {w}_{k 1} \\ = Bias + noise\end{matrix} & ( 40 )\end{matrix}$$

The result is a Gaussian random variable with a mean M. The variance about the mean is

$${σ}_{δ {v}_{hk}}^{2} = \frac{1}{{\vert {b}_{k}^{k} \vert}^{2}} E [ {( {\sum }_{k 1 \neq k} {K}_{k 1} {w}_{k 1} )}^{2} ] \qquad ( 41 )$$

If the satellite random errors are uncorrelated, then (41) can be written as

$${σ}_{δ {v}_{hk}}^{2} = \frac{1}{{\vert {b}_{k}^{k} \vert}^{2}} {\sum }_{k 1 \neq k} {K}_{k 1}^{2} E [ {w}_{k}^{2} ] \qquad ( 42 )$$

Since the normalized random delta-range errors are all unity variance, the RMS value of the random horizontal position errors in the direction of satellite k is

$$\begin{matrix}\begin{matrix}{σ}_{δ {v}_{hk}} = \frac{1}{\vert {b}_{k}^{k} \vert} \sqrt{{\sum }_{k 1 \neq k} {K}_{k 1}^{2}} \\ = \frac{1}{\vert {b}_{k}^{k} \vert} \sqrt{{\sum }_{k 1 \neq k} [ {( \frac{{\overline{s}}_{k}^{h} \cdot {\overline{s}}_{k 1}^{h}}{\vert {\overline{s}}_{k}^{h} \vert} \vert {b}_{k}^{k} \vert - \vert {\overline{s}}_{k}^{h} \vert {b}_{k 1}^{k} )}^{2} ]}\end{matrix} & ( 43 )\end{matrix}$$

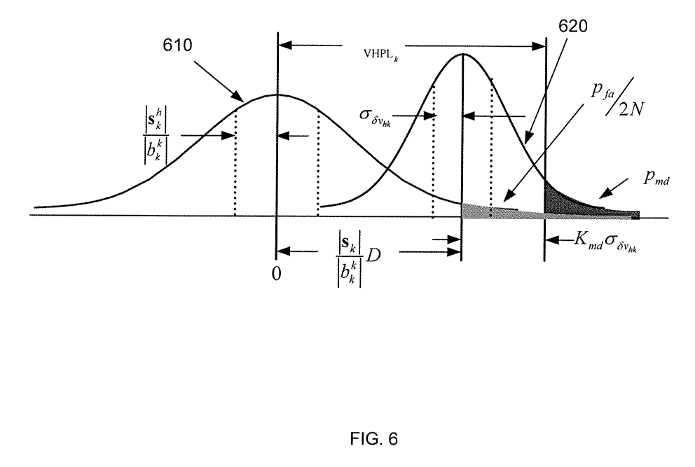

The horizontal protection level (HPL) is set such that the probability of exceeding it due to the bias plus the above random error is p_{md} (=0.001). We define this sigma multiplier here as K_{md}. FIG. 6 illustrates the resulting HPL. The distribution 610 centered at zero (in red) represents the fault-free distribution in parity space transformed onto the line-of-sight of satellite k and then transformed into the horizontal plane as if all of the errors were pseudo range errors of satellite k. It is not a true horizontal position error distribution, but is shown here so that the fault-free parity distribution and the faulted horizontal position error distribution can all be illustrated in FIG. 6. The distribution 620 represents the true distribution of the horizontal position error with a fault in satellite k, such that the parity error (discriminator) is at the threshold D.

From FIG. 6, it can be seen that the HPL for a failure in satellite k is calculated as

$${HVPL}_{k} = \frac{\vert {\overline{s}}_{k} \vert}{\vert {b}_{k}^{k} \vert} D + {K}_{md} {σ}_{δ {r}_{hk}} \qquad ( 44 )$$

The discriminator must be tested for all N visible satellites and each can fail either positive or negative. Thus, the processor 16 divides by 2N the allowed probability of false alarm for each test as indicated in FIG. 6. The threshold D is set such that the probability of exceeding it (with no failure) meets this allocated probability of false alarm. The sigma multiplier that achieves this may be denoted as K_{fa}. Thus (44) can be re-written as

$${HVPL}_{k} = \frac{\vert {\overline{s}}_{k}^{h} \vert}{\vert {b}_{k}^{k} \vert} {K}_{fa} + {K}_{md} {σ}_{δ {v}_{hk}} \qquad ( 45 )$$

The processor 16 repeats the HPL calculation for all N satellites, each time rotating the parity space such that the impact of a bias on that satellite is entirely along axis 1. The overall HPL is then

HVPL=max(HVPLₖ), k=1, N (46)

While a preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A navigation system for a vehicle having a receiver operable to receive a plurality of signals from a plurality of transmitters, the navigation system comprising:
a processor; and
a memory device having stored thereon machine-readable instructions that, when executed by the processor, enable the processor to:
determine a set of error estimates corresponding to delta pseudo-range measurements derived from the plurality of signals,
determine an error covariance matrix for a main navigation solution, and
using a parity space technique, determine at least one protection level value based on the error covariance matrix.

2. The system of claim 1 wherein the instructions further enable the processor to determine a set of error estimates corresponding to pseudo-range measurements derived from the plurality of signals.

3. The system of claim 1 wherein the instructions further enable the processor to determine an error covariance matrix for at least one navigation sub-solution, wherein the at least one sub-solution processes one fewer transmitter than does the main solution.

4. The system of claim 1 wherein determining at least one protection level comprises determining a parity vector having a magnitude.

5. The system of claim 4 wherein determining at least one protection level value further comprises determining a discriminator value based on the parity-vector magnitude.

6. The system of claim 5 wherein:
the plurality of signals is received from six or more transmitters of the plurality of transmitters; and
the discriminator value comprises the square of the parity-vector magnitude.

7. The system of claim 6 wherein determining at least one protection level comprises determining a failure threshold of the discriminator value from a chi-square probability distribution.

8. The system of claim 1 wherein determining at least one protection level comprises determining a parity scalar.

9. The system of claim 8 wherein:
the plurality of signals is received from five transmitters of the plurality of transmitters; and
determining at least one protection level value further comprises determining a discriminator value from the parity scalar.

10. The system of claim 9 wherein determining at least one protection level comprises determining a failure threshold of the discriminator value.

11. The system of claim 1 wherein the at least one protection level value comprises a horizontal-velocity integrity value.

12. A navigation system for a vehicle having a receiver operable to receive a plurality of signals from a plurality of transmitters, the navigation system comprising:
a processor; and
a memory device having stored thereon machine-readable instructions that, when executed by the processor, enable the processor to:
determine, using a bank of least-square-solution processes, a bank of error covariance matrices and navigation solutions associated with horizontal and vertical velocity states of the vehicle, and
based on the matrices and navigation solutions, determine, using a parity space technique, at least one protection level value associated with said velocity states.

13. The system of claim 12 wherein the set of values corresponds to delta pseudo-range measurements derived from the plurality of signals.

14. The system of claim 12 wherein determining the bank of error covariance matrices comprises determining an error covariance matrix for a main navigation solution.

15. The system of claim 14 wherein determining the bank of error covariance matrices comprises determining an error covariance matrix for at least one navigation sub-solution, wherein the at least one sub-solution processes one fewer transmitter than does the main solution.

16. The system of claim 12 wherein determining at least one protection level comprises determining a parity vector having a magnitude.

17. The system of claim 12 wherein determining at least one protection level comprises determining a failure threshold of a discriminator value from a chi-square probability distribution.

18. The system of claim 12 wherein the at least one protection level value comprises a horizontal-velocity integrity value.

19. A computer-readable medium having computer-executable instructions for performing steps comprising:
determining a set of error estimates corresponding to delta pseudo-range measurements derived from the plurality of signals;
determining an error covariance matrix for a main navigation solution;
using a parity space technique, determining at least one protection level value based on the error covariance matrix.

20. A method, comprising the steps of:
accessing from a first computer the computer-executable instructions of claim 19; and
providing the instructions to a second computer over a communications medium.
